(19) United States
(12) Patent Application Publication
(10) Pub. No.: US 2012/0267807 A1
(43) Pub. Date: Oct. 25, 2012

(54) MESH STRUCTURE FOR SURFACE PLASMON RESONANCE SPECTROSCOPY

(75) Inventor: Benno Steinbrecht, Gutersloh (DE)

(73) Assignee: SONOPRESS GmBH, GUTERSLOH (DE)

(21) Appl. No.: 13/499,525

(22) PCT Filed: Sep. 6, 2010
(86) PCT No.: PCT/EP2010/063042

§ 371 Date: Jul. 11, 2012

(30) Foreign Application Priority Data
Oct. 1, 2009 (DE) 10 2009 047 922.8

(51) Int. Cl. B29C 59/02

(52) U.S. Cl. 264/2.5

(57) ABSTRACT

The invention relates to producing a profiled mesh structure on a substrate for use in surface plasmon resonance spectroscopy, wherein a flat board is coated with a positive photoresist, the photoresist is illuminated in parallel tracks corresponding to the mesh constant, subsequently developed, and the development interrupted before the development process reaches the surface of the board. After metallizing and galvanically molding the developed and rinsed surface profile, a matrix is available allowing low-cost molding of the substrate from a thermoplastic material.

The invention relates to a method for producing a grating structure having an approximately sinusoidal profile on the surface of a substrate for use in surface plasmon resonance spectroscopy.

Surface plasmon resonance spectroscopy makes use of the interaction of light with the surface plasmons of a solid and makes it possible to investigate the interaction between immobile receptors and analytes in a liquid film. To this end, the liquid film flows along the profiled surface of a substrate. It is known from the theory that the best results are achieved when the surface has a grating structure with an approximately sinusoidal profile.

It is difficult to produce such a grating structure with grating spacings and structural heights in the nanometer to micrometer range. Production of individual items typically requires two days according to dissertation by A. H. Nicol, “Grating Coupled Surface Plasmon Enhanced Fluorescence Spectroscopy,” chapter 3.1, September 2005, Johannes Gutenberg University of Mainz A clean glass substrate is coated with a photoresist on which holographic interference lines are produced, exposing the photoresist to varying extents. After developing and curing the photoresist, the surface has a sinusoidal profile, which is transferred by means of ionic etching to the surface of the glass substrate, which is then covered with a gold film by vapor deposition. To be reused, the gold film must be removed and a new gold film applied to the glass substrate.

U.S. Pat. No. 5,550,663 A describes an optical low-pass filter having an essentially sinusoidal surface profile. To produce this profile, a thermoplastic photoresist material is applied to a substrate and then exposed through a mask. After developing, the remaining photoresist material has a crenellated surface profile, i.e., it has a sequence of rectangular blocks in cross section and rectangular or square grooves or trenches. Next the photoresist material is heated to its melting point until a surface having an approximately sinusoidal curve has formed due to the blocks fusing with the grooves or trenches.

The object of the invention is to create a method of the generic type described in the introduction which will make it possible to produce a large number of substrates with a grating structure having an approximately sinusoidal profile inexpensively.

This object is achieved according to the invention by a method having the following steps:
(a) Coating a flat plate with a positive photoresist,
(b) Exposing the photoresist with a laser beam in at least approximately parallel tracks microscopically, with a track spacing equal to a predetermined value of the grating constant and a diffraction-limited track width of approximately half of the track spacing,
(c) Developing the exposed photoresist by means of a developer liquid,
(d) Terminating the developing by rinsing before the developing process reaches the surface of the plate,
(e) Metallizing the surface profile thereby created,
(f) Making an impression of a template galvanically,
(g) Producing the substrate from a thermoplastic material by taking an impression of the template.

Although the steps (a), (c) and (d) are known from the dissertation cited above, the method proposed here differs from the method described in the dissertation in the direct exposure of a photoresist in step (b), the metallization of the developed surface profile without the intermediate step of transfer of the surface profile to the surface of the flat plate in step (e) and taking an impression of a template galvanically in step (f), which in turn permits the production of any number of substrates according to step (g).

Advantageous details of the method according to the invention are given in claims 2 through 10.

The method according to the invention is explained below with reference to the drawings, which illustrate individual steps of the method in schematically simplified form and in particular are not drawn to scale. They show:

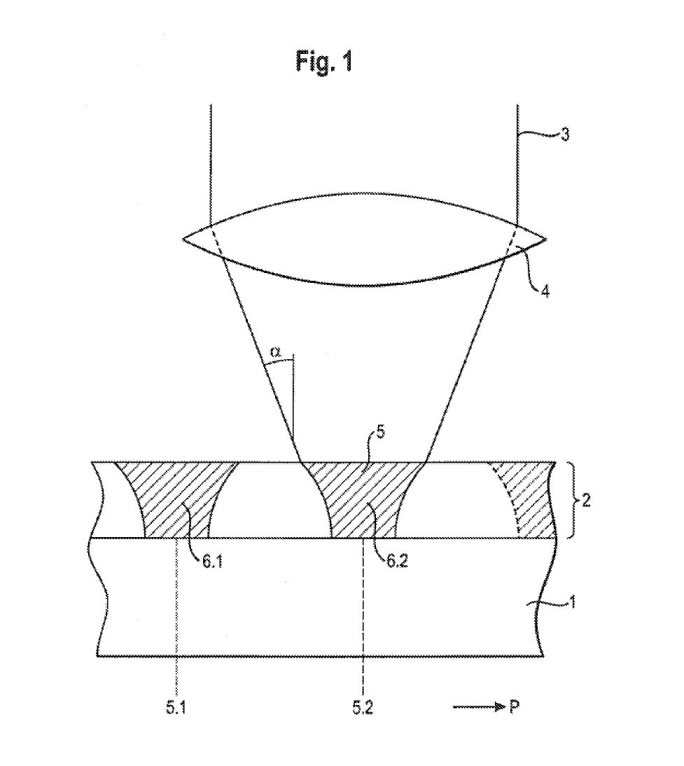

FIG. 1: a detail of a glass substrate with a photoresist coating during exposure in a section at a right angle to the direction of the tracks,

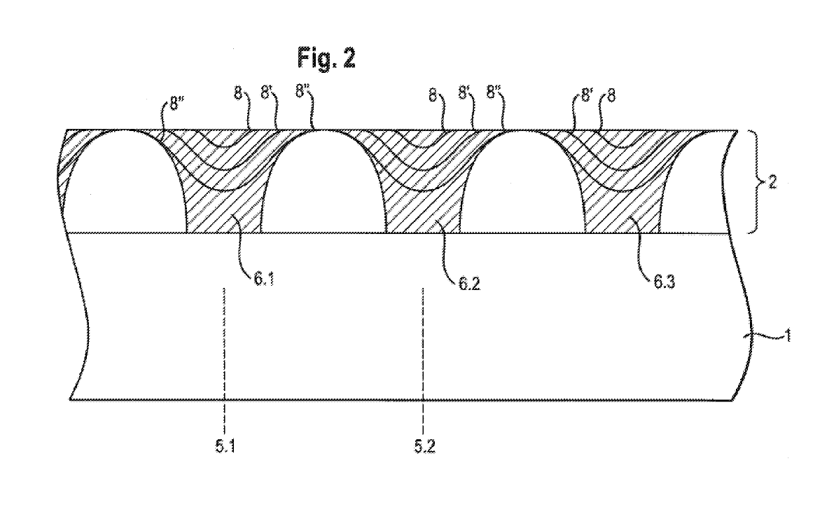

FIG. 2: the time-dependent progress of the development of the photoresist

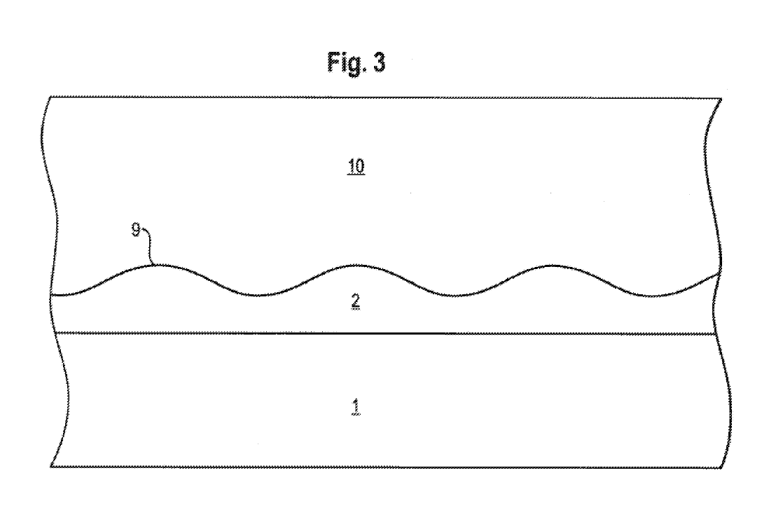

FIG. 3: making an impression of the sinusoidal profiling of the photoresist galvanically and

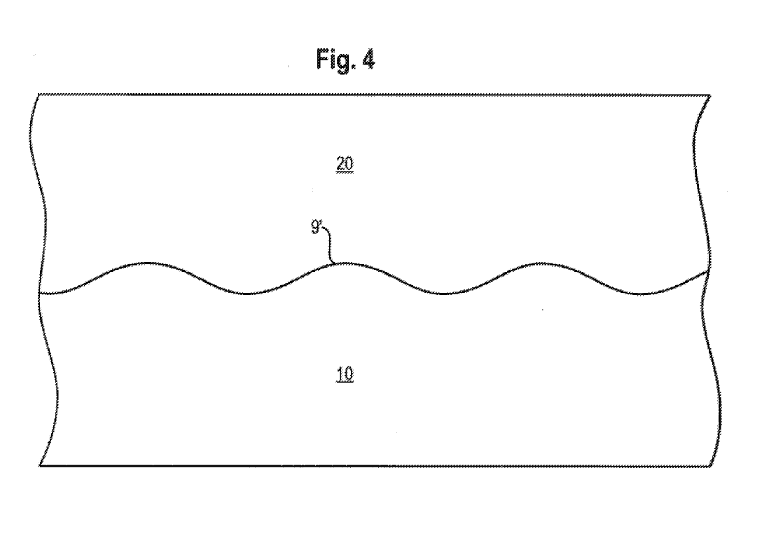

FIG. 4: the production of a substrate by making an impression of the template.

FIG. 1 shows a detail from a carrier plate 1 which may be a glass plate in particular. The flat polished and cleaned surface of the plate 1 is coated with a positive photoresist according to any known method, e.g., by spin coating. The layer thickness is adjusted by adjusting the viscosity of the photoresist and in the case of spin coating, the rotational speed of the plate 1. The latter depends on the use of the substrate-to-be within the context of surface plasmon resonance spectroscopy and may amount to between 30 nm and 10 μm. A layer thickness of more than 70 nm is preferred, so that the development of the photoresist following the exposure described below does not extend to the surface of the plate 1. A suitable photoresist solution consists of Mikroposit S 1805 (brand name), mixed with EC solvent (brand name) in a 1:4 ratio. In spin coating, the rotational speed in this example may be approximately 600 μm. After coating, the photoresist is dried, e.g., at 80° C. for 30 minutes. These parameters may be varied within wide limits.

After drying the photoresist layer 2 is exposed with a laser beam 3 to later produce the most sinusoidal structure possible, this laser beam initially having a diameter of a few millimeters, limited by an aperture (not shown here). This laser beam is focused by means of a lens 4 on a diffraction-limited diameter which depends in particular on the selected wavelength of the laser beam. In the range of visible light, this focus diameter may be in the range of 1 μm, for example. The focus is preferably approximately in the plane of the surface of the plate 1. The numeric aperture NA, which is a measure of the acceptance angle a of the focused laser beam, determines the distance between the lens 4 and the surface of the photoresist layer 2 and also determines the diameter of the diffraction-limited focus.

To create the grating structure, the photoresist layer 2 is exposed in tracks such as 5.1, 5.2, whose spacing is on the order of magnitude of the wavelength used in the context of surface plasmon resonance spectroscopy, in accordance with the subsequent grating constant, i.e., in the range of 100 nm to at least 10 μm. The next track still to be produced by exposure is shown with dotted lines. To produce the tracks, the plate 1 and the laser beam 3 are moved in relation to one another, preferably by rotating the plate 1 about an axis parallel to the central axis of the focus laser beam and by translatory displacement of the laser beam according to the arrow P, either incrementally after a full rotation or continuously during the rotation by an amount which is equal to the desired grating constant. Macroscopically concentrated tracks are produced in the former case, whereas a spiral track is produced in the latter case. Microscopically both cases result in approximately parallel tracks with a track spacing equal to the predetermined value of the grating constant and a diffraction-limited track width which is adjusted by means of the lens 4 to approximately half of this track spacing.

Since the radial intensity profile of the focused laser beam does not have a sinusoidal curve, the intensity of the laser beam is reduced as a function of the relative velocity between the plate 1 and the laser beam 4 to the extent that the photoresist is not completely exposed. Furthermore, the optical properties of the lens 4 are selected, so that, in combination with at least one aperture, the intensity distribution in the photoresist is approximately sinusoidal over the width of the track(s). The parameters are determined case by case empirically and taking into account the nonlinear development process, which is described with reference to FIG. 2.

If the tracks are written in a circle or spiral, then it is possible to work either at a constant angular velocity or at a constant linear velocity. In the former case the intensity of the laser beam must be regulated as a function of the distance from the axis of rotation so that the intensity of the exposure of the photoresist remains constant locally. In the latter case the intensity need not be altered once it has been set. For the photoresist coating described above and a linear velocity of the beam of approximately 1.2 m/s, for example, it is possible to work with a beam intensity of approximately 2.3 mW.

The areas 6.1, 6.2 shown with hatching in FIG. 1 may indicate the exposed volumes of the photoresist layer 2 because in fact there are no sharp boundaries between exposed and unexposed areas of the photoresist.

After being exposed, the photoresist is developed with a 0.05 to 5% NaOH solution. The photoresist is positive, i.e., the exposed areas are dissolved in developing. The more intense the exposure, the more rapidly the development process proceeds. As indicated by the profile 8 in FIG. 2, it begins in the middle of the respective exposure area and dissolves the exposed photoresist in both depth and width. The profile 8′ illustrates an intermediate stage. In relation to the development process on a flat surface of the photoresist, the development process is accelerated in convex areas and is decelerated in concave areas. This therefore results in the rounded patterns in the surface profile of the photoresist layer 2, as indicated in the drawing. Development is terminated when the profile 8″ connects the neighboring exposed volumes 6.1, 6.2, 6.3. This point in time is determined empirically. The development process is terminated by rinsing with ultrapure water. With the values given above and developing with 0.25% NaOH solution, the developing process is terminated after approximately 15 seconds. The photoresist layer 2 then has a surface with an approximately sinusoidal profile across the direction of the track.

This surface is then metallized. To do so, a film a few nanometers thick, preferably of nickel, alternatively of copper, silver or gold, is applied by essentially known methods such as sputtering, vapor deposition (CVD) or deposition from solution. In an essentially known manner, the plate 1 having the sinusoidally profiled and now electrically conductive surface of the photoresist layer 2 is electroplated with a metal layer, preferably nickel, which is both inexpensive and has a high stability. This is shown in FIG. 3. As its surface 9, this metal layer 10 has the negative of the profile of the surface of the photoresist layer 2. This negative which is very stable in relation to the photoresist, is separated from the photoresist layer 2, during which the latter is usually destroyed.

The metal layer 10 produced in this way can now be used as a stable template for producing almost any number of substrates 20 according to FIG. 4 having the desired grating structure 9′ with an approximately sinusoidal profile. The essentially known injection molding process as well as other known casting methods are suitable for this purpose. Plastics suitable for the substrate include polycarbonate or PMMA, among others.

1. A method for producing a grating structure having an approximately sinusoidal profile on the surface of a substrate for use for surface plasmon resonance spectroscopy, comprising the steps:
(a) Coating a flat plate with a positive photoresist,
(b) Exposing the photoresist with a laser beam in at least approximately parallel tracks microscopically with a track spacing equal to a predetermined value of the grating constant and a diffraction-limited track width of approximately half of the track spacing,
(c) Developing the exposed photoresist by means of a developer liquid,
(d) Terminating the developing by rinsing before the developing process reaches the surface of the plate,
(e) Metallizing the surface profile thereby created,
(f) Making an impression of a template,
(g) Producing the substrate from a thermoplastic material by taking an impression of the template.

2. The method according to claim 1, characterized in that a glass plate is used as the flat plate.

3. The method according to claim 1, characterized in that the flat plate is coated with the photoresist by the spin coating method.

4. The method according to claim 1, characterized in that the laser beam and the plate are moved in relation to one another at a linear velocity which is determined empirically as a function of the beam intensity such that the photoresist is not exposed all the way to the surface of the flat plate.

5. The method according to claim 1, characterized in that the tracks are written macroscopically by rotating the plate in relation to the laser beam.

6. The method according to claim 5, characterized in that the tracks are written macroscopically as a continuous spiral.

7. The method according to claim 5, characterized in that the tracks are written macroscopically concentrically.

8. The method according to claim 1, characterized in that the photoresist is exposed with a focused laser beam whose focus is in the area of the interface between the surface of the flat plate and the photoresist.

9. The method according to claim 1, characterized in that the development is terminated shortly before the neighboring tracks formed by the development begin to merge together.

10. The method according to claim 1, characterized in that the developed and rinsed surface profile is metallized by sputtering.

11. The method according to claim 2, characterized in that the flat plate is coated with the photoresist by the spin coating method.

12. The method according to any one of claims 2 characterized in that the laser beam and the plate are moved in relation to one another at a linear velocity which is determined empirically as a function of the beam intensity such that the photoresist is not exposed all the way to the surface of the flat plate.

13. The method according to any one of claims 11, characterized in that the laser beam and the plate are moved in relation to one another at a linear velocity which is determined empirically as a function of the beam intensity such that the photoresist is not exposed all the way to the surface of the flat plate.

14. The method according to claim 2, characterized in that the tracks are written macroscopically by rotating the plate in relation to the laser beam.

15. The method according to claim 11, characterized in that the tracks are written macroscopically by rotating the plate in relation to the laser beam.

16. The method according to claim 13, characterized in that the tracks are written macroscopically by rotating the plate in relation to the laser beam.

17. The method according to claim 7, characterized in that the photoresist is exposed with a focused laser beam whose focus is in the area of the interface between the surface of the flat plate and the photoresist.

18. The method according to claim 17, characterized in that the development is terminated shortly before the neighboring tracks formed by the development begin to merge together.

19. The method according to claim 18, characterized in that the developed and rinsed surface profile is metallized by sputtering.
